(19) United States
(12) Patent Application Publication
(10) Pub. No.: US 2006/0077693 A1
(43) Pub. Date: Apr. 13, 2006

(54) Liquid crystal display and a backlight module thereof

(75) Inventors: Chun-Min Ko, Chang Hua Hsien (TW); Jun-Hsian Lao, Keelung City (TW)

Correspondence Address: BRUCE H. TROXELL, SUITE 1404, 5205 LEESBURG PIKE, FALLS CHURCH, VA, 22041, US

(73) Assignee: AU Optronics Corp.

(21) Appl. No.: 11/184,961

(22) Filed: Jul. 20, 2005

(30) Foreign Application Priority Data
Oct. 8, 2004 (TW) 93216023

(51) Int. Cl. F21V 7/04

(52) U.S. Cl. 362/633

(57) ABSTRACT

A liquid crystal display (LCD) having a frame, a light guide, a panel, a flexible printed circuit (FPC) board, and an illuminating unit is provided. The frame has a first groove formed on a first sidewall thereof. The light guide positioned inside the frame has a first protrusion engaged with the first groove to prevent the deformation of the frame. The display panel is positioned above the light guide. The FPC board has a first end and a second end. The first end is connected to the display panel and the second end is attached to the bottom surface of the frame. The illuminating unit is bonded on the FPC board for providing light toward the incident surface of the light guide.

### BACKGROUND OF THE INVENTION

This application claims the priority benefit of Taiwan patent application serial no. 93216023, filed on Oct. 8, 2004.

(1) Field of the Invention

This invention relates to a liquid crystal display (LCD) and a backlight module thereof, and more particularly, relates to an LCD and a backlight module thereof using light emitting diodes (LEDs) as light source.

(2) Description of Related Art

The development of thin film transistor (TFT) fabrication technology facilitates the application of liquid crystal panels among various electronic products, such as personal digital assistant (PDA), notebook, digital camera, digital video, and cell phone, etc. A backlight module, which is utilized as a planar light source, is integrated with the liquid crystal panel, which cannot self-illuminate. The backlight module usually needs some cold cathode fluorescent lamps (CCFLs) as light source to radiate light beam passing through some optical films, such as diffuser, polarizer, etc., to uniformly illuminate the liquid crystal panel for displaying images.

Liquid display displays (LCDs) with slimmer size and less weight are helpful to the development of portable electronic products. For achieving this object, light emitted diodes (LEDs) with the advantage of small size is concerned to replace the traditional CCFLs as the light source applied in the backlight module.

FIG. 1 shows a cross-section view of a typical LCD 100 using LEDs 190 as backlight source. The LCD 100 includes a bezel 120, a frame 130, a light guide 140, an LCD panel 150, a first flexible printed circuit (FPC) board 160, a second FPC board 170, and at least an LED 190. The frame 130 is utilized for supporting the light guide 140 and to constrain the LCD panel 150 right above the light guide 140. The first FPC board 160 is connected to the LCD panel 150 for applying displaying control signals. The second FPC board 170 is connected to part of the bottom surface of the frame 140. The LED 190 is assembled on the second FPC board 170 and leans a sidewall of the light guide 140 for providing illumination to the LCD panel 150. The bezel 120 is assembled outside the frame 130 for fixing the LCD panel 150.

As shown in FIG. 1, the displaying control signal and the illumination control signal are applied to the LCD panel 150 and the LED 190 through the two FPC boards 160 and 170 individually. In order to reduce the number of parts within the LCD for saving fabrication cost, in a different case as shown in FIG. 2A, a single multi-ftmction FPC board 180 is used to functional replace the first FPC board 160 and the second FPC board 170. For connecting the LCD panel 150 and the bottom surface of the frame 130 simultaneously to apply displaying control signal and keep the LED 190 leaning the light guide 140, the FPC board 180 needs to be twisted.

It should be noted that the twisted FPC board 180 performs a tendency to recover the original straight situation and generates a force F to the connected LCD panel 150, the connected LED 190, and the frame 130. Since the LCD panel 150 has a better toughness with respect to the frame 130 and is usually firmly constrained on the frame 130, as shown in FIG. 2B, the force F provided by the FPC 150 may bend the frame 130 downward to have the LED 190 leaving the sidewall of the light guide 140 and inclined the direction of illumination L to result illumination leakage.

In order to maintain the uniformity and brightness of the illumination provided to the LCD panel 150, and also the displaying quality, a frame 130 with less deformation is required to keep the relative positions of the LED 190 and the light guide 140 inside the LCD.

### SUMMARY OF THE INVENTION

The present invention has been made focusing on the LCD using single FPC board and has a main object of reducing the illumination leakage due to the twisted FPC board.

The present invention provides a liquid crystal display (LCD) comprising a frame, a light guide, a display panel, an FPC board, and an illuminating unit. The frame has a first groove formed on a first sidewall thereof. The light guide positioned inside the frame has a first protrusion engaged with the first groove. The display panel is positioned on the light guide. The FPC board has a first end and a second end. The first end is connected to the display panel and the second end is attached to the bottom surface of the frame. The illuminating unit is bonded on the FPC board for providing light toward the incident surface of the light guide.

Reference will now be made in detail to the preferred embodiments of the present invention, examples of which are illustrated in the accompanying drawings. Wherever possible, the same reference numbers will be used throughout the drawings to refer to the same or like parts.

### BRIEF DESCRIPTION OF THE DRAWINGS

The present invention will now be specified with reference to its preferred embodiment illustrated in the drawings, in which:

FIG. 1 shows a cross-section view of a typical LCD having an LED as backlight source;

FIG. 2A shows a cross-section view of a typical LCD using a single flexible printed circuit (FPC) board;

FIG. 2B shows a cross-section view depicting the frame bent by the FPC board shown in FIG. 2A.

FIG. 3A shows a cross-section view of a preferred embodiment of the LCD in the present invention;

FIG. 3B shows a top view of the LCD shown in FIG. 3A;

FIG. 3C shows a cross-section view along the a-a direction of FIG. 3B and depicting the forces applied to the frame;

FIG. 3D shows a cross-section view along the b-b direction of FIG. 3B;

FIG. 4 shows a cross-section view of a second embodiment of the LCD in the present invention; and

FIG. 5 shows a cross-section view of a third embodiment of the LCD in the present invention.

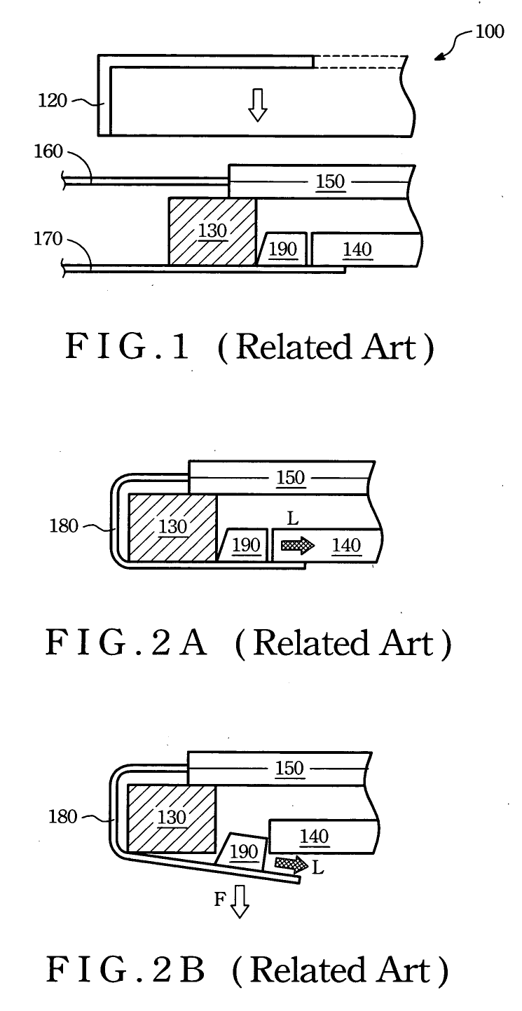

### DETAIL DESCRIPTION OF THE PREFERRED EMBODIMENTS

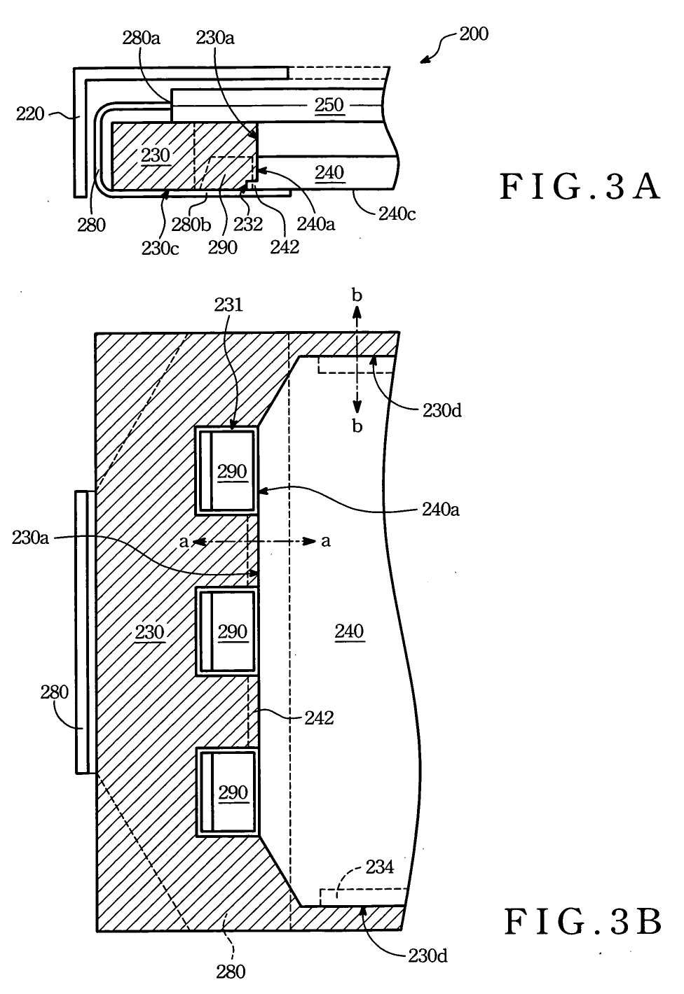

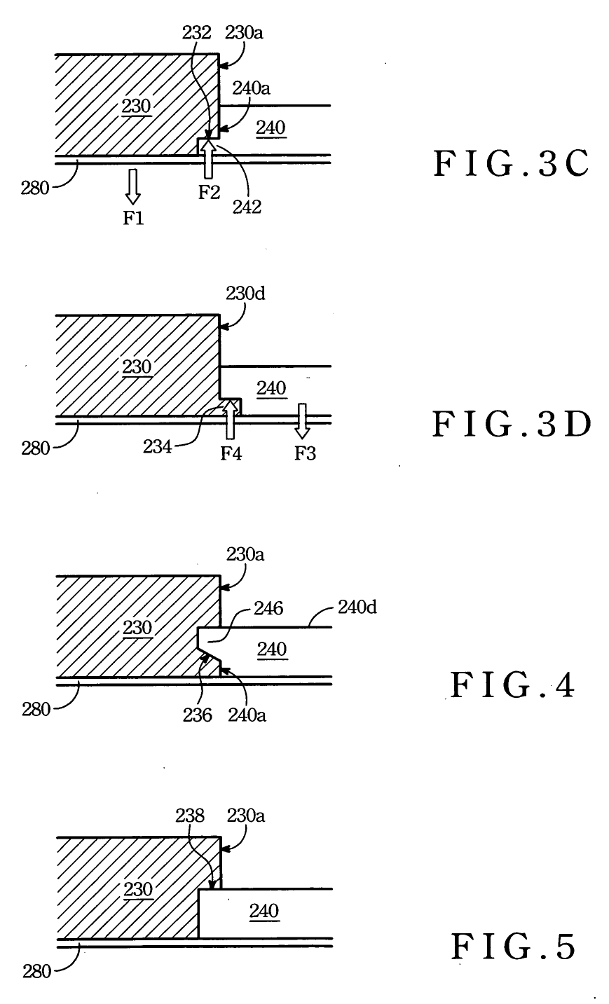

FIG. 3A shows a cross-section view of a first preferred embodiment of an LCD 200 in the present invention. The LCD 200 includes a bezel 220, a frame 230, a light guide 240, a display panel 250, a flexible printed circuit (FPC) board 280, and at least an illuminating unit 290.

The light guide 240 is assembled in the bottom portion inside the frame 230 and supported by the frame 230. A reflective layer (not shown in this figure) is formed on a bottom surface of the light guide 240 for increasing illumination efficiency and reducing light leakage. The display panel 250 is positioned above the light guide 240 and supported by the frame 230. A preset space is kept between the display panel 250 and the light guide 240 for allocating some proper optical films (not shown in this figure), such as diffuser, polarizer, etc., to increase the uniformity of light applied to the display panel 250.

The FPC board 280 has a first end 280a and a second end 280b. The first end 280a is connected to the display panel 250 and the second end 280b is attached to a bottom surface 230c of the frame 230. That is, the FPC board 280 is twisted to extend from the display panel 250, along the outer surface of the frame 230, and reach the bottom surface 230c of the frame 230. A gluing layer (not shown in this figure) is interposed between FPC board 280 close to the second end 280b and the bottom surface 230c of the frame 230 to have the FPC board 280 firmly adhered to the frame 230. The illuminating unit 290 is bonded on the FPC board 280, so that as the FPC board 280 is assembled to the frame 230, the illuminating unit 290 can lean on the incident surface 240a of the light guide 240 for providing light. The bezel 220 is assembled outside the frame 230 and the FPC board 280 to restrict the upward movement of the display panel 250 with respect to the frame 230.

The incident surface 240a of the light guide 240 has a first protrusion 242 extending along the bottom surface 240c toward the frame 230. A first sidewall 230a of the frame 230 adjacent to the incident surface 240a has a first groove 232. The first protrusion 242 is engaged with the first groove 232 so as to keep the frame 230 in place and prevent the frame 230 from being bent by the FPC board 280 to result light leakage.

FIG. 3B shows a top view depicting the LCD shown in FIG. 3A with the bezel 220 and the display panel 250 being removed to show the backlight module. As shown, the first sidewall 230a of the frame 230 has three openings 231 for accommodating the illuminating units 290. The first grooves 232 on the first sidewall 230a are located between neighboring openings 231 and adjacent to the illuminating units 290. The illuminating units 290 inside the openings are set to lean on the incident surface 240a of the light guide 240 for providing illumination. It is also understood that the light emitting diodes (LED) may be utilized as the illuminating unit 290 to reduce the size and the weight of the LCD in the present invention.

FIG. 3C shows a cross-section view along a-a direction of FIG. 3B. The vertical position of the glass display panel 250 is restricted by the bezel 220, so that the twisted FPC board 280 connected to the display panel 250 provides a force F1 to bend the frame 230 downward. Since the light guide 240 has a greater toughness than the plastic frame 230, the force F1 may be balanced by an upward force F2 provided by the first protrusion 242 to prevent the frame 230 from being deformed. Thereby, the illuminating unit 290 on the FPC board 280 may be kept in place to lean on the incident surface 240a to prevent the light leakage event as shown in FIG. 2B.

It should be noted that once an upward force F2 is applied to the frame 230, a reverse force F3 facing downward is simultaneously applied on the first protrusion 242 to maintain equilibrium. As shown in FIG. 3D, which represents a cross-section view along b-b direction shown in FIG. 3B, a second sidewall 230d of the frame 230 has a second protrusion 234 extending toward the light guide 240 to provide an upward force F4 supporting the light guide 240 and balance the reverse force F3.

FIG. 4 shows a cross-section view depicting a second preferred embodiment of the LCD in the present invention. By contrast to the LCD shown in FIG; 3C, which specifies a first protrusion 242 extending from the bottom surface 240c of the light guide 240, the present embodiment has a third protrusion 246 on the incident surface 240a extends toward the frame 230 from the upper surface 240d of the light guide 240. The respective first sidewall 230a of the frame has a third groove 236 engaged with the third protrusion 246 to prevent the frame 230 from being deformed.

FIG. 5 shows a cross-section view depicting a third preferred embodiment of the LCD in the present invention. By contrast to the LCD shown in FIG. 3C, which specifies the first protrusion 242 extending along the bottom surface 240c of the light guide 240, the present embodiment has a fourth groove 238 formed on the first sidewall 230a of the frame 230. The whole edge of the incident surface of the light guide 240 is engaged with the fourth groove 238 to prevent the frame 230 from being deformed.

By contrast to the tradition LCD shown in FIG. 2B, which has a major drawback of light leakage due to the bent frame 130, the present invention uses the existed light guide 240 with higher toughness to engage with the frame 230, so as to hinder the deformation of the frame 230. Thus, only a minor alteration of the frame 230 and the light guide 240 is demanded in the present invention to achieve the object of preventing light leakage.

With the example and explanations above, the features and spirits of the invention will be hopefully well described. Those skilled in the art will readily observe that numerous modifications and alterations of the device may be made when retaining the teaching of the invention. Accordingly, the appended claims are intended to cover all embodiments without departing from the spirit and scope of the present invention.

We claim:

1. A backlight module for providing light to a display panel, comprising:
a frame having a first groove formed on a first sidewall thereof;
a light guide, positioned inside the frame, having a first protrusion engaged with the first groove;
a flexible printed circuit (FPC) board having a first end and a second end, the first end of the FPC board being connected to the display panel, and the second end of the FPC board being attached to the bottom surface of the frame; and
an illuminating unit, bonded on the FPC board, for providing light toward the incident surface of the light guide.

2. The backlight module of claim 1, wherein the first protrusion extends along the bottom surface of the light guide toward the frame.

3. The backlight module of the claim 1, wherein the first sidewall of the frame comprises an opening to accommodate the illuminating unit.

4. The backlight module of claim 3, wherein the first groove is formed adjacent to the illuminating unit.

5. The backlight module of claim 1, wherein the illuminating unit comprises a light emitting diode (LED).

6. The backlight module of claim 1, wherein a second sidewall of the frame near to the light guide has a second protrusion extending toward the light guide to support the light guide.

7. A liquid crystal display (LCD) comprising:
a frame, having a first groove formed on a first sidewall thereof;
a light guide, positioned in a bottom portion of the frame, having a first protrusion extending along the bottom surface of the light guide toward the frame engaged with the first groove, and the light guide has a toughness better than the frame;
a display panel, positioned on the light guide;
an FPC board, having a first end and a second end, the first end of the FPC board being connected to the display panel, and the second end of the FPC board being attached to the bottom surface of the frame;
at least an LED, bonded on the FPC board and leaning on the incident surface of the light guide for providing light.

8. The LCD of claim 8, wherein the first sidewall of the frame is adjacent to the incident surface and comprises at least an opening to accommodate the LED.

9. The LCD of claim 9, wherein the first groove is formed adjacent to the LED.
